(19) United States
(12) Patent Application Publication
(10) Pub. No.: US 2019/0384067 A1
(43) Pub. Date: Dec. 19, 2019

(54) SYSTEM AND METHOD FOR VIEWING OF TWO-DIMENSIONAL COLOR IMAGES THAT SIMULATE DEPTH WITH COLOR

(71) Applicant: Merlin Industries, Inc., Hamilton, NJ (US)

(72) Inventors: James Zell, Newtown, PA (US); Andrew Maggion, Lambertville, NJ (US)

(21) Appl. No.: 16/441,184

(22) Filed: Jun. 14, 2019

Related U.S. Application Data
(60) Provisional application No. 62/686,123, filed on Jun. 18, 2018.

(51) Int. Cl. G02B 27/22; H04N 13/332; H04N 13/324

(52) U.S. Cl. CPC G02B 27/2221; H04N 2213/008; H04N 13/324; H04N 13/332

(57) ABSTRACT

A system and method for viewing of two-dimensional (2D) color-encoded images that simulate depth with color include a pair of goggles, the goggles having two lenses that each include a high chromatic dispersive prism disposed adjacent a low chromatic dispersive prism, and a 2D color-encoded image being viewable with the lenses of the goggles which separate colors of the image into different convergence points in the visual field of a user, thereby producing a chromostereoscopic effect.

### CROSS-REFERENCE TO RELATED APPLICATION

This application claims the benefit of U.S. Provisional Patent Application No. 62/686,123, filed on Jun. 18, 2018, the entire contents of which are hereby incorporated by reference herein.

### FIELD OF THE INVENTION

The invention relates generally to chromostereoscopic devices and systems, and more particularly, to chromostereoscopic methods and systems to view two-dimensional color-encoded images to produce an image in which depth is perceived by a user.

### BACKGROUND OF THE INVENTION

Three-dimensional (3D) stereoscopic glasses operate by providing an anaglyphic image in which the right component of a composite image, usually red in color, is superposed on the left component in a contrasting color, usually blue (or green), to produce a three-dimensional effect when viewed through correspondingly colored filters in the form of spectacles or glasses. If the composite image is viewed without the colored filters, the image appears blurred or incomprehensible, and is not aesthetically pleasing.

Other optical viewing devices may contain far field holograms that reconstruct an object in a far field when viewing discrete points of light. The holograms have a spatially varying amplitude and phase transmittance that mimics the absorption and phase delays that would be experienced from viewing an actual object. The optically-formed hologram is made by recording a complicated fringe pattern made by an interfering reference beam (often a plane wave) and a beam that has been bounced off the subject object. The net result is a mask with the appropriate absorption and phase delays across the hologram. Computer generated holography uses a computer to calculate the interference of the reference beam with an object beam. A data file is created that describes the fringe pattern. The pattern is then transferred onto a piece of film or other medium that bends (diffracts) light coming from a plane wave (or a distant point source) in such a manner as to mimic the complicated wavefront that would have come off of an object had it actually been present. Thus, when viewing a scene through a far field hologram, and looking at a point source of light, the light is focused by the lens and cornea of the eye to a point in the retina where the object reconstructs.

Contrary to most display hologram applications in which the observer is encouraged to not focus all attention on the holographic diffracted light pattern, the observer of a far field hologram focuses on an overall scene in a unique combination with the holographic diffracted light patterns at each bright point source of light present in the scene. For example, a hologram image of a heart or snowman will be visible when viewing a street light or other discrete points of light.

Unlike 3D systems and holograms, a chromostereoscopic effect, i.e., stereo-vision (depth perception) through color is achieved based on the differences in the diffraction of color in an image when viewed through glasses or other viewing devices having binary optics (two prisms) as the lenses. A color-encoded image is prepared on either a black or white background, and when viewed through the binary optic lenses, depth is perceived by the viewer. When viewing the image without the lenses, the image still appears aesthetically pleasing, unlike 3D anaglyphs, which are blurred or incomprehensible.

The use of the aforementioned chromostereoscopic technology has not been utilized in entertainment methods and systems.

Accordingly, there is a need for entertainment products and facilities that employ chromostereoscopic technology.

### SUMMARY OF THE INVENTION

According to an aspect of the invention, a system for underwater viewing of two-dimensional (2D) color-encoded images that simulate depth with color, includes a pair of airtight and watertight goggles, the goggles having two lenses that each include a high chromatic dispersive prism disposed adjacent a low chromatic dispersive prism; and a 2D color-encoded image, the image being viewable underwater with the lenses of the goggles which separate colors of the image into different convergence points in a visual field of a user, thereby producing a chromostereoscopic effect.

According to another aspect of the invention, a method for underwater viewing of two-dimensional (2D) color-encoded images that simulate depth with color includes the steps of: providing a pair of airtight and watertight goggles, the goggles having two lenses that each include a high chromatic dispersive prism disposed adjacent a low chromatic dispersive prism; and providing a 2D color-encoded image, the image being viewable underwater with the lenses of said goggles which separate colors of the image into different convergence points in a visual field of a user, thereby producing a chromostereoscopic effect.

According to another aspect of the invention, an underwater chromostereoscopic image system includes a pool containing water; a two-dimensional (2D) color-encoded image formed onto a pool liner in the pool; and a pair of airtight and watertight goggles, the goggles having two lenses that each include a high chromatic dispersive prism disposed adjacent a low chromatic dispersive prism, wherein the image is viewable underwater with the lenses of the goggles which separate colors of the image into different convergence points in a visual field of a user, thereby producing a chromostereoscopic effect.

### BRIEF DESCRIPTION OF THE DRAWINGS

Throughout the drawings, like reference numerals are used to indicate common features of the described devices.

FIG. 1 is an illustration of the binary optics employed in the invention, in which a high dispersion prism is disposed in front of a low dispersion prism according to an aspect of the invention;

FIG. 2 is an illustration of the binary optics employed in the invention, in which a low dispersion prism is disposed in front of a high dispersion prism according to an aspect of the invention;

FIG. 3 is an illustration of the binary optics employed in the invention, in which the high dispersion prism is disposed adjacent a low dispersion prism according to an aspect of the invention;

FIG. 4 is an elevational view illustrating the viewing device for underwater viewing of 2D color-encoded images, according to an aspect of the invention;

FIG. 5 is an exemplary image which includes red, orange, yellow, green, and blue on a black background according to an aspect of the invention;

FIG. 6 is an exemplary image which includes red, orange, yellow, green, blue, black, and white on a dark blue background according to an aspect of the invention;

FIG. 7 is an exemplary image which includes cyan, magenta and yellow on a white background according to an aspect of the invention;

FIG. 8 is another exemplary image which includes red, green, and orange on a black background according to an aspect of the invention;

FIG. 9 is another exemplary image which includes orange and blue on a dark blue background according to an aspect of the invention; and

FIG. 10 is another exemplary image which includes orange and black on a dark blue background according to an aspect of the invention.

The above-identified drawing figures set forth several preferred embodiments of the invention. Other embodiments are also contemplated, as disclosed herein. The disclosure represents the invention, but is not limited thereby, as it should be understood that numerous other modifications and embodiments may be devised by those skilled in the art which fall within the scope and spirit of the invention as claimed.

### DETAILED DESCRIPTION OF THE INVENTION

As used herein, the terms “comprises”, “comprising”, “includes”, “including”, “has”, “having”, or any other variation thereof, are intended to cover non-exclusive inclusions. For example, a process, method, article or apparatus that comprises a list of elements is not necessarily limited to only those elements but may include other elements not expressly listed or inherent to such process, method, article, or apparatus. In addition, unless expressly stated to the contrary, the term “of” refers to an inclusive “or” and not to an exclusive “or”. For example, a condition A or B is satisfied by any one of the following: A is true (or present) and B is false (or not present); A is false (or not present) and B is true (or present); and both A and B are true (or present).

The terms “a” or “an” as used herein are to describe elements and components of the invention. This is done for convenience to the reader and to provide a general sense of the invention. The use of these terms in the description herein should be read and understood to include one or at least one. In addition, the singular also includes the plural unless indicated to the contrary. As used in this specification and the appended claims, the term “or” is generally employed in its sense including “and/or” unless the content clearly dictates otherwise.

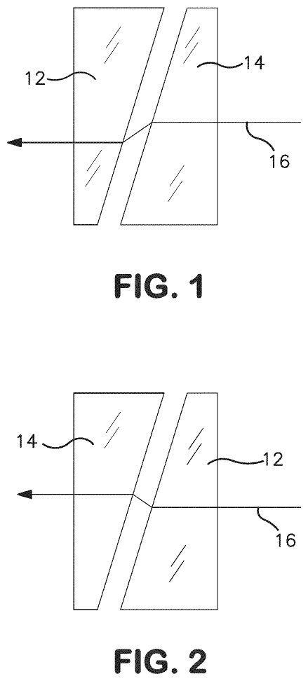

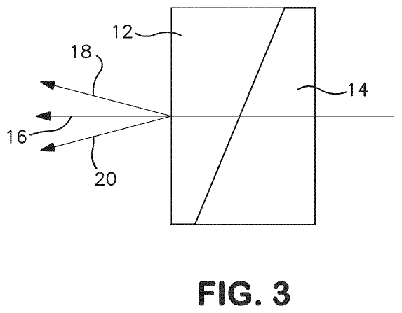

Referring to FIG. 1, the binary optics according to an aspect of the invention for use in a pair of underwater goggles provide that each pair of prisms 12 and 14 are placed in front of each eye. The prisms 12 and 14 are placed with the bases in opposition with one prism being made of high dispersion material 12 and the other being made of low dispersion material 14. The prisms 12 and 14 are designed so that yellow light 16 entering the first prism 14 passes through the other prism 12 and emerges parallel to the entering beam. The bending of light is somewhat exaggerated in FIG. 1 to illustrate that although the yellow light 16 passes undeviated in angle through the prisms 12 and 14, and remains in the same plane of entry, other colors do not. For example, red light 20 (FIG. 3) passes through prism 14 with only a slight deviation from the yellow light 16 because prism 14 is made of low dispersion material. Prism 12, however, causes a significant deviation in the angle of the emerging red beam 20 from the emerging yellow beam 16. The effect is similar fora blue beam of light 18 except that the blue beam 18 will be diverged from the yellow light 16 in the opposite direction. The prisms may be in the form of a film disposed on a transparent substrate.

Referring to FIG. 2, an opposite color-depth arrangement can be achieved when the arrangement of the prisms of FIG. 1 are reversed in that the low dispersion prism 14 is placed before the high dispersion prism 12, with the prism base orientations reversed. This arrangement provides that distant objects are colored blue, with objects in the middle ground being colored yellow green, while objects in the foreground are colored red. Although the double prisms are shown slightly separated in FIGS. 1 and 2, it should be understood that they may be joined so that there is no air gap between each prism, as illustrated in FIG. 3. The prisms may be in the form of a film disposed on a transparent substrate.

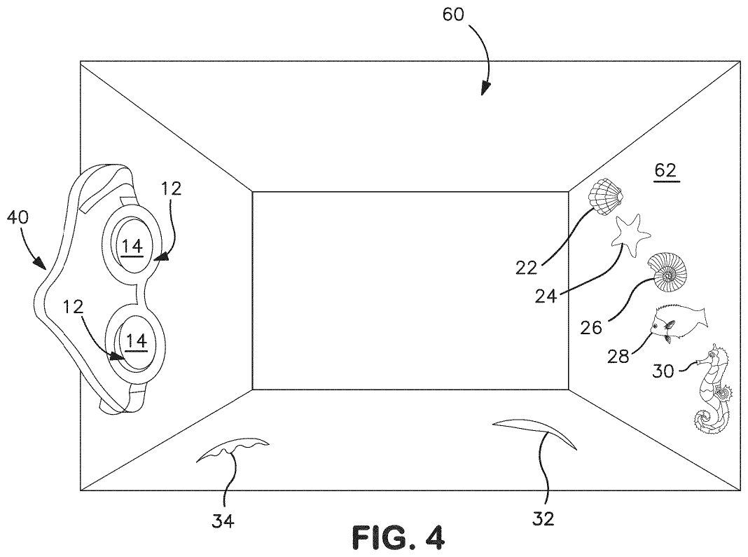

Referring to FIG. 4, a pair of airtight and watertight goggles 40 are shown as would be worn by a user underwater in a pool 60, and 2D color-encoded images are illustrated on a wall 62 of an in-ground or above-ground swimming pool 60 with the colors red 22 (seashell), orange 24 (starfish), yellow 26 (snail), green 28 (fish), and blue 30 (seahorse). When wearing the goggles 40, the user viewing the 2D color-encoded image (when the prism closest to the eyes of the viewer is a high dispersion prism 12 and the front of the goggles 40 has a low dispersion prism 14) will interpret the color red 22 to appear closer to the eyes than the yellow 26, and the blue 30 will appear farthest away from the eyes, even though all of the colors are in 2D. The opposite color-depth arrangement can be achieved when the prisms are reversed, i.e., the low dispersion prism 14 is closest to the eyes and the high dispersion prism 12 is on the outer surface of the lens. Additional colors, for example, black 32 and white 34 may also be employed.

Suitable materials for forming the double prisms include, for example, as first material/second material: acrylic/styrene, acrylic/cassia oil, acrylic/quinolone, glycerine/cassia oil, almond oil/cassia oil, almond oil/anise oil, water/anise oil, glycerine/quinolone, and acrylic/ethyl cinnimate, although other suitable materials may be used. The prisms may be formed on a thin film of material as well, and disposed onto commercially-available swim goggles.

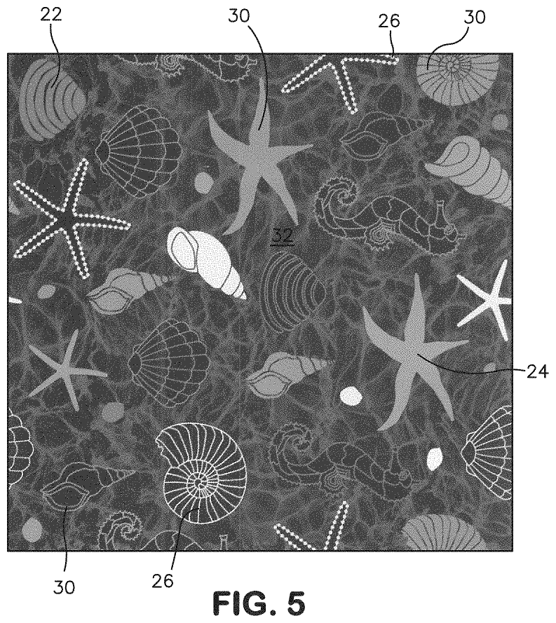

Referring to FIGS. 5-10, exemplary 2D color-encoded images formed for use in the invention are provided. The images are merely an example of the many images that may be formed, and remain the same once formed, i.e., a computer does not change the image from time to time. It should be noted, however, that the images advantageously appear aesthetically pleasing, even without the double prism lenses. The images may be formed by a computer program, or by hand, if desired. The image may also appear to have the form of a ceramic tile, but the image of the tile may be formed on a vinyl liner. In addition, viewing the images underwater is enhanced by the movement of the water, which makes the images appear to move. Sunlight entering the pool also enhances the viewing of the images.

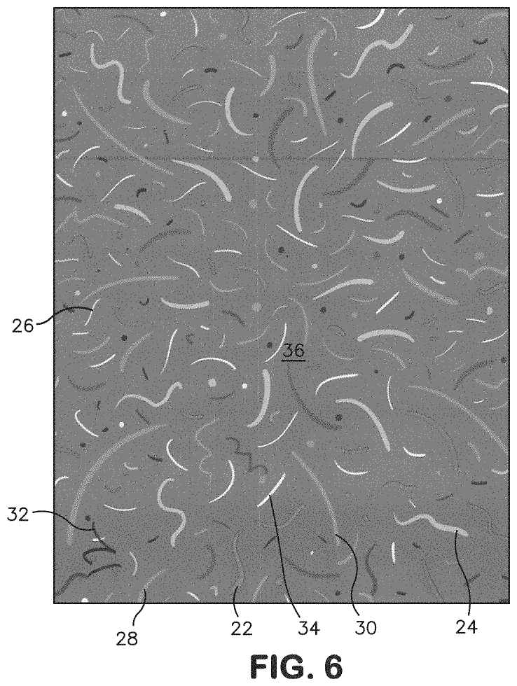

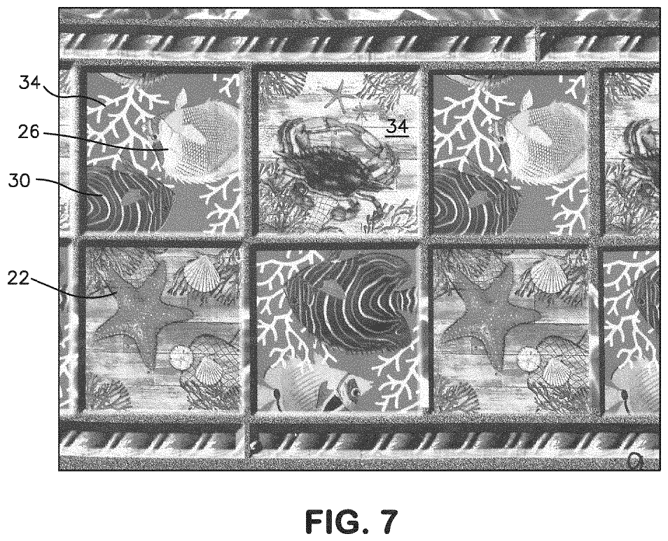

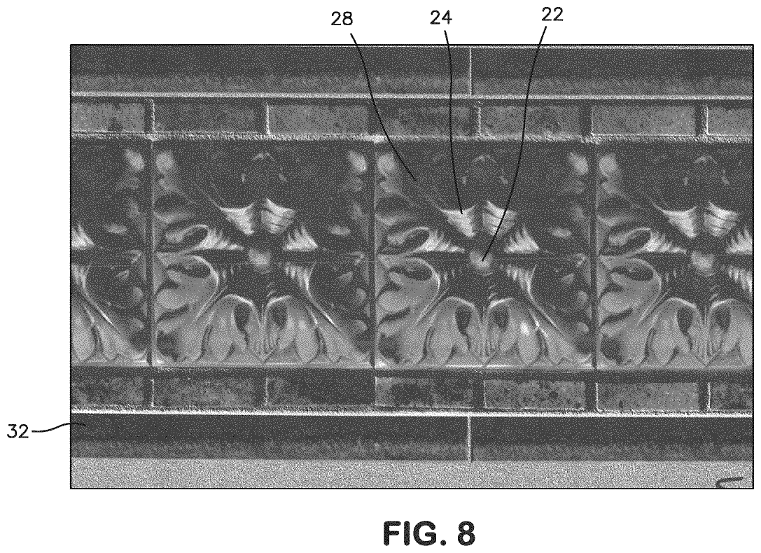

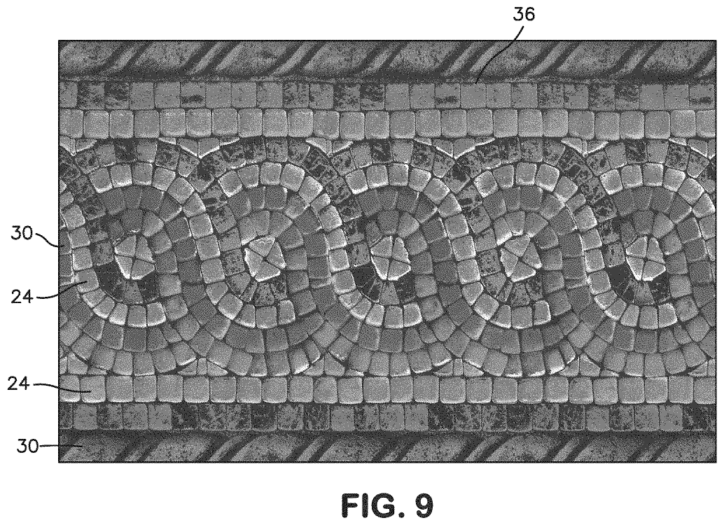

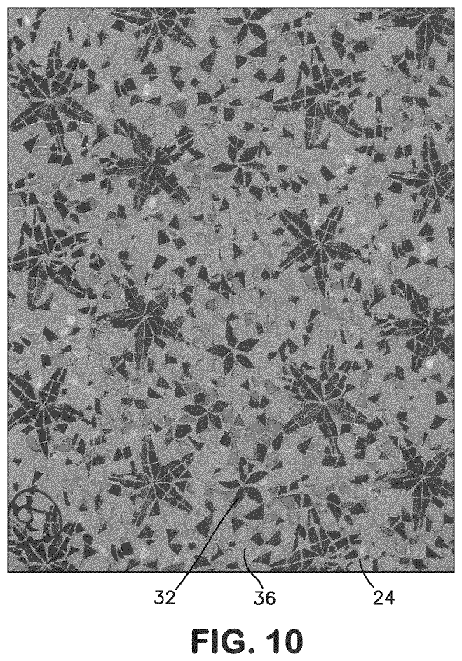

For example, FIG. 5 is an exemplary image which includes red 22, orange 24, yellow 26 and blue 30 on a black 32 background according to an aspect of the invention. FIG. 6 is an exemplary image which includes red 22, orange 24, yellow 26, green 28, blue 30, black 32 and white 34 on a dark blue 36 background according to an aspect of the invention. FIG. 7 is an exemplary image which includes blue 30 (or cyan), red 22 (or magenta) and yellow 26 on a white 34 background according to an aspect of the invention. FIG. 8 is another exemplary image which includes red 22, green 28, and orange 24 on a black 32 background according to an aspect of the invention. FIG. 9 is another exemplary image which includes orange 24 and blue 30 on a dark blue 36 background according to an aspect of the invention. FIG. 10 is another exemplary image which includes orange 24 and black 32 on a dark blue background 36 according to an aspect of the invention.

The invention has been described with reference to specific embodiments. One of ordinary skill in the art, however, appreciates that various modifications and changes can be made without departing from the scope of the invention as set forth in the claims. Accordingly, the specification is to be regarded in an illustrative manner, rather than with a restrictive view, and all such modifications are intended to be included within the scope of the invention.

What is claimed is:

1. A system for underwater viewing of two-dimensional (2D) color-encoded images that simulate depth with color, comprising:
a pair of airtight and watertight goggles, said goggles having two lenses that each include a high chromatic dispersive prism disposed adjacent a low chromatic dispersive prism; and
a color-encoded 2D color image, said image being viewable underwater with said lenses of said goggles which separate colors of said image into different convergence points in a visual field of a user, thereby producing a chromostereoscopic effect.

2. The system according to claim 1, wherein said image is formed onto a pool liner.

3. The system according to claim 4, wherein said image includes red, orange, yellow, green, and blue on a black background.

4. The system according to claim 4, wherein said image includes red, orange, yellow, green, blue, black, and white on a dark blue background.

5. The system according to claim 4, wherein said image includes cyan, magenta and yellow on a white background.

6. The system according to claim 1, wherein said image is formed onto ceramic tiles for a pool.

7. The system according to claim 6, wherein said image includes red, orange, yellow, green, and blue on a black background.

8. The system according to claim 6, wherein said image includes red, orange, yellow, green, blue, black, and white on a dark blue background.

9. The system according to claim 6, wherein said image includes cyan, magenta and yellow on a white background.

10. The system according to claim 1, wherein said prisms are in the form of a thin film of material.

11. A method for underwater viewing of two-dimensional (2D) color-encoded images that simulate depth with color, comprising the steps of:
providing a pair of airtight and watertight goggles, said goggles having two lenses that each include a high chromatic dispersive prism disposed adjacent a low chromatic dispersive prism; and
providing a 2D color-encoded image, said image being viewable underwater with said lenses of said goggles which separate colors of said image into different convergence points in a visual field of a user, thereby producing a chromostereoscopic effect.

12. The method according to claim 11, wherein said high chromatic dispersive prism is disposed in front of said low chromatic dispersive prism.

13. The method according to claim 11, wherein said low chromatic dispersive prism is disposed in front of said high chromatic dispersive prism.

14. The method according to claim 11, wherein said image is formed onto a pool liner.

15. The method according to claim 14, wherein said image includes red, orange, yellow, green, and blue on a black background.

16. The method according to claim 14, wherein said image includes red, orange, yellow, green, blue, black, and white on a dark blue background.

17. The method according to claim 14, wherein said image includes cyan, magenta and yellow on a white background.

18. The method according to claim 14, wherein said image is formed onto ceramic tiles for a pool.

19. The method according to claim 11, wherein said prisms are in the form of a thin film of material.

20. An underwater chromostereoscopic image system, comprising:
a pool containing water;
a two-dimensional (2D) color-encoded image formed onto a pool liner in said pool; and
a pair of airtight and watertight goggles, said goggles having two lenses that each include a high chromatic dispersive prism disposed adjacent a low chromatic dispersive prism, wherein said image is viewable underwater with said lenses of said goggles which separate colors of said image into different convergence points in a visual field of a user, thereby producing a chromostereoscopic effect.
